(19) United States
(12) Patent Application Publication
(10) Pub. No.: US 2023/0352953 A1
(43) Pub. Date: Nov. 2, 2023

(54) BATTERY CHARGING STATION

(71) Applicant: Murata Vios, Inc., Woodbury, MN (US)

(72) Inventors: Atsuhiko HIRATA, Woodbury, MN (US); Nobuhiro KONDO, Woodbury, MN (US); Masamichi YANAI, Woodbury, MN (US)

(21) Appl. No.: 18/309,737

(22) Filed: Apr. 28, 2023

Related U.S. Application Data
(60) Provisional application No. 63/336,641, filed on Apr. 29, 2022.

(51) Int. Cl. H02J 7/00

(52) U.S. Cl. CPC H02J 7/0045; H02J 7/0013

(57) ABSTRACT

A charger assembly including a housing with a first surface, a second surface that is not parallel with the first surface, a first recess in the first surface, a second recess in the second surface, and a first opening connecting the first recess and the second recess. The charger assembly further includes a first group of electrical contacts in the first recess and a second group of electrical contacts in the second recess. Each of the first recess and the second recess is configured to receive a battery pack.

### CROSS REFERENCE TO RELATED APPLICATIONS

This application claims the benefit of U.S. Patent Application No. 63/336,641 filed on Apr. 29, 2022. The entire contents of this application are hereby incorporated by reference.

### BACKGROUND OF THE INVENTION

### 1. Field of the Invention

The present invention relates to a battery charging station. In particular, the present invention relates to a battery charging station for battery packs that can be used with patient-worn monitoring devices.

### 2. Description of the Related Art

Many different types of patient monitoring systems require a direct electrical interface to the skin of a patient. In some applications, the direct electrical interface to the patient's skin is to sense electrical signals present at that skin location; while in other applications, the direct electrical interface is to apply an electrical current stimulation signal at that skin location. Therefore, the patient monitoring systems typically require a patient-worn sensor assembly that detects, records, and communicates patient data. As such, the patient-worn sensor assembly can include several structural features that can provide increased signal quality, reduction in signal noise, increased patient comfort, increased reliability, and increased adhesion to a patient's skin.

The patient-worn sensor can sense vital-sign information, such as blood pressure, body temperature, respiratory rate, blood oxygenation, electrocardiogram (ECG), heart rhythm, heart rate, blood glucose level, and hydration (bio-impedance) levels, etc. The patient-worn sensor can also track and record additional information about patients, including patient movement, activity, and sleep patterns.

A conventional patient-worn sensor collects information sensed at the patient's skin and wirelessly transmits the data to another device of a monitoring system (e.g., bed-side monitor, tablet device, mobile phone, central processing server, etc.), which in turn can be connected to a network system of a hospital, clinic, or home-based monitoring system. Such a patient-worn sensor can include an adhesive electrode assembly with multiple individual electrodes that are attached to the patient's skin, and a sensor assembly that includes all of the sensing, processing, and communication electronics, and a power supply in a self-contained sensor-transmitter device. In this conventional patient-worn sensor, the electrode assembly provides a direct electrical interface, an adhesive to attach to the patient's skin, and a platform to which the sensor assembly connects and is supported by.

FIG. 1 shows a conventional patient-worn sensor of an ECG monitoring system that includes an adapter-sensor assembly 1000 with separate adapter 1110 and sensor 1120 and several leads for connecting to a patient's skin. The two-piece adapter-sensor assembly 1000 includes the sensor 1120 attached to the adapter 1110. The adapter 1110 can be attached to a patient's skin by tacky monitoring electrodes. As shown in FIG. 1, the leads can include, for example, a Mod lead to sense respiration sensing and ECG leads such as an RA lead, an LL lead, and a V lead. The leads are located at the end of cables connected to the adapter-sensor assembly 1000. The leads snap onto electrodes that are adhered to the patient's skin. As discussed below, the adapter-sensor assembly 1000 includes snaps on the rear that attach to electrodes. As shown, the patient-worn sensor can also include a pulse oximeter (ox) sensor 1131 that can be clipped onto the patient's finger to measure oxygen saturation level. FIG. 2 shows that the adapter-sensor assembly 1000 can be attached to a patient's chest area 1180 with cables 1140 connected to the leads that are attached to patient's right-hand side and to an area near the patient's waist. The cable 1130 for the pulse ox sensor 1131 is attached to the patient's left-hand side. Conventional patient-worn sensors are cumbersome because pulse ox sensor cables 1130 are only attached to the left side of a patient-worn sensor, for example, as shown in FIG. 2. Accordingly, routing the pulse ox sensor 1131 to a patient's right hand in the configuration shown in FIG. 2 would require inconvenient routing of the cable 1130 over or around the adapter-sensor assembly 1000 creating unnecessary excess slack in the wiring.

FIG. 3 is a perspective view of the conventional adapter 1110, and FIG. 4 is a perspective view of the conventional sensor 1120. The adapter 1110 can include a push tab 1114, a socket connector (hidden in the view but located near the push tab 1114), arms 1116, and an area in which the cables of leads 1140 and a cable 1130 of the pulse ox sensor 1131 are attached. The socket connector receives a mating electrical connector 1123 on the sensor 1120. The push tab 1114 on the adapter 1110 is used with a push tab 1124 on the sensor 1120 to join and disconnect the sensor 1120 from the adapter 1110. The arms 1116 are located on opposing sides of the adapter 1110 to align and secure the sensor 1120.

As shown in FIG. 4, the sensor 1120 can include the electrical connector 1123 and the push tab 1124. The electrical connector 1123 plugs into the socket connector of the adapter 1110 and is used to transmit and receive power and electrical signals between the sensor 1120 and the adapter 1110. As shown, the sensor 1120 also includes a receptacle 1125 that can be used to charge a battery (not shown) in the sensor 1120 or to transmit/receive data when the sensor 1120 is not connected to the adapter 1110. FIG. 5 shows how the sensor 1120 can be aligned by the arms 1116 of the adapter 1110 and moved in the direction of the arrow to engage the electrical connector 1123 into the socket connector on the adapter 1110. FIG. 6 shows the adapter-sensor assembly 1000 with the sensor 1120 in place and fully engaged with the adapter 1110.

However, since sensor 1120 is a self-contained sensor-transmitter device that includes sensor and transmitter components, as well as a battery to supply power to the sensor and transmitter components, the sensor and transmitter components of the adapter-sensor assembly 1000 must be removed in order to recharge or replace the battery. Accordingly, the structure of the adapter-sensor assembly 1000 is inconvenient to users and results in the sensor 1120, although replaceable, being a relatively expensive component.

In addition, the sensor 1120 must be programmed or otherwise associated with an identity of a patient to which the adapter 1110 is attached. Thus, if a sensor 1120 with a depleted battery is simply replaced by another sensor 1120 with a charged battery, the replacement sensor 1120 must also be programmed or otherwise associated with the identity of the patient to which the adapter 1110 is attached. Accordingly, the structure of the adapter-sensor assembly 1000 causes further inconvenience and cost by requiring programming or other association with a patient for each sensor 1120.

Furthermore, the battery of the sensor 1120 can only be charged by an external power supply that is connected via a cable or the like to the receptacle 1125. Accordingly, it may be difficult for a user to simultaneously charge the batteries of multiple sensors 1120 since a separate cable and charging connection is required for each sensor 1120. In addition, the sensor 1120 is not able to be readily mounted to a wall or the like while charging the sensor 1120 due to the cabled charging connection of the sensor 1120.

### SUMMARY OF THE INVENTION

To overcome the problems described above, preferred embodiments of the present invention provide battery charging stations of battery packs that can be used with patient-worn monitoring devices.

A charger assembly according to a preferred embodiment of the present invention includes a housing with a first surface, a second surface that is not parallel with the first surface, a first recess in the first surface, a second recess in the second surface, and a first opening connecting the first recess and the second recess. The charger assembly further includes a first group of electrical contacts in the first recess and a second group of electrical contacts in the second recess. Each of the first recess and the second recess is configured to receive a battery pack.

The charger assembly may further include a charging status indicator.

The charger assembly may further include a first printed circuit board (PCB) electrically connected to the first group of electrical contacts and a second PCB electrically connected to the second group of electrical contacts. The first PCB and the second PCB may have identical shapes.

The housing may further include a third recess in the first surface and a fourth recess in the second surface. The housing may further include a second opening that connects the third recess and the fourth recess.

The charger assembly may further include a detachable wall mount bracket. A first angle between the first surface of the housing and the detachable wall mount bracket may be equal to a second angle between the second surface of the housing and the detachable wall mount bracket. The charger assembly may further include shoulder screws or nobs provided on the detachable wall mount bracket and keyholes provided in the housing. The keyholes may receive the shoulder screws or nobs when the charger assembly is attached to the detachable wall mount bracket. The charger assembly may further include a tab provided on the wall mount bracket and a latch provided on or in the housing. The latch may engage the tab when the charger assembly is attached to the detachable wall mount bracket.

The charger assembly may further include a detachable base plate. The detachable base plate may be perpendicular to the first surface and the second surface.

An angle between the first surface and the second surface may be changeable.

A charger system according to a preferred embodiment of the present invention may include a charger assembly according to one of the various other preferred embodiments of the present invention, a first battery pack in the first recess, and a second battery pack in the second recess. Both the first battery pack and the second battery pack may be removable from the charger assembly using the first opening.

The above and other features, elements, characteristics, steps, and advantages of the present invention will become more apparent from the following detailed description of preferred embodiments of the present invention with reference to the attached drawings.

### BRIEF DESCRIPTION OF THE DRAWINGS

FIG. 1 shows a conventional patient-worn sensor of an ECG monitoring system.

FIG. 2 shows a conventional patient-worn sensor in contact with a patient's skin.

FIG. 3 shows a conventional adapter that can be used with the patient-worn sensor of FIG. 1.

FIG. 4 shows a conventional sensor that can be used with the patient-worn sensor of FIG. 1.

FIGS. 5 and 6 show a conventional adapter-sensor assembly.

FIG. 7 shows a top view of a patient monitoring device that protects electrical connections from water intrusion and corrosion.

FIG. 8 shows a bottom view of the patient monitoring device shown in FIG. 7.

FIG. 9 shows a top view of the chest device of the patient monitoring device shown in FIG. 7 with cables removed.

FIG. 10 shows a bottom view of the battery pack of the patient monitoring device shown in FIG. 7.

FIG. 11 shows a cross-sectional view of the patient monitoring device shown in FIG. 7.

FIG. 12 shows an enlarged portion of the cross-sectional view shown in FIG. 11.

FIGS. 13 and 14 show perspective views of internal components of the chest device and the battery pack of the patient monitoring device shown in FIG. 7.

FIG. 15 shows a top perspective view of a charging station that can be used with the battery pack shown in FIG. 10.

FIG. 16 shows a close-up view of a portion of the charging station shown in FIG. 15.

FIG. 17 shows a bottom perspective view of the charging station shown in FIG. 15.

FIG. 18 shows a mounting bracket included with the charging station shown in FIG. 15.

FIGS. 19 and 20 show a plurality of the charging stations shown in FIG. 15 mounted in vertical and horizontal orientations.

FIG. 21 shows a modification of the mounting bracket shown in FIG. 18 to include end caps.

FIGS. 22 and 23 show top and bottom views of the modified mounting bracket shown in FIG. 21 attached to the charging station shown in FIG. 15.

FIG. 24-26 show an example of attaching the mounting bracket shown in FIG. 21 to the charging station shown in FIG. 15.

FIGS. 27-31 show an example of a spring latch of the charging station shown in FIG. 15 mating with a folded tab of the mounting bracket shown in FIG. 17.

FIGS. 32-37 show a vertical mount stand for the charging station shown in FIG. 15.

FIGS. 38 and 39 show a power supply included with the vertical mount stand and the charging station shown in FIGS. 32-37.

FIGS. 40 and 41 show internal views of components for the power supply shown in FIGS. 38 and 39.

FIGS. 42 and 43 are perspective and top views of internal components of the charging station shown in FIG. 15.

FIG. 44 shows a cross-sectional view of the charging station shown in FIG. 15.

FIG. 45 is a cross-sectional view of modified bays of the charging station shown in FIG. 15.

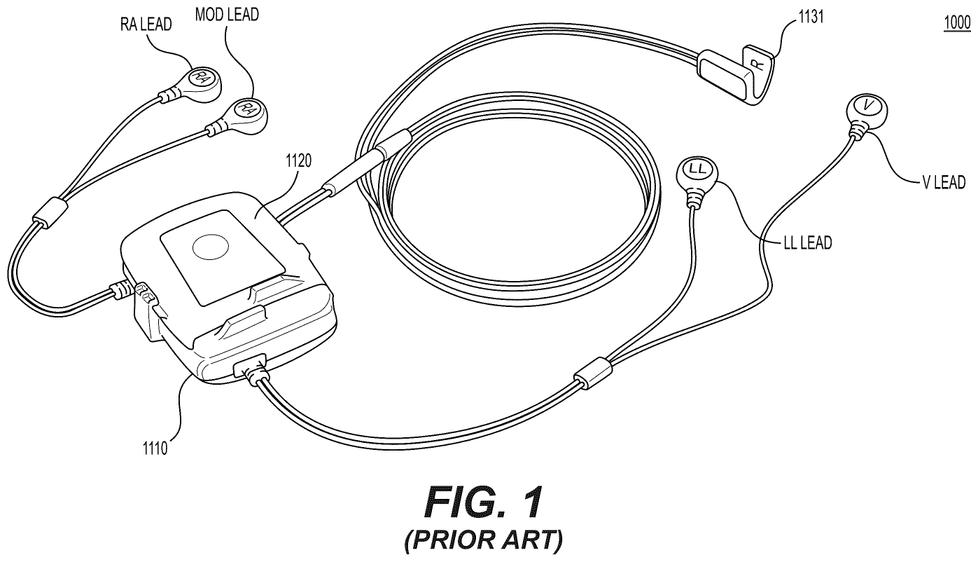

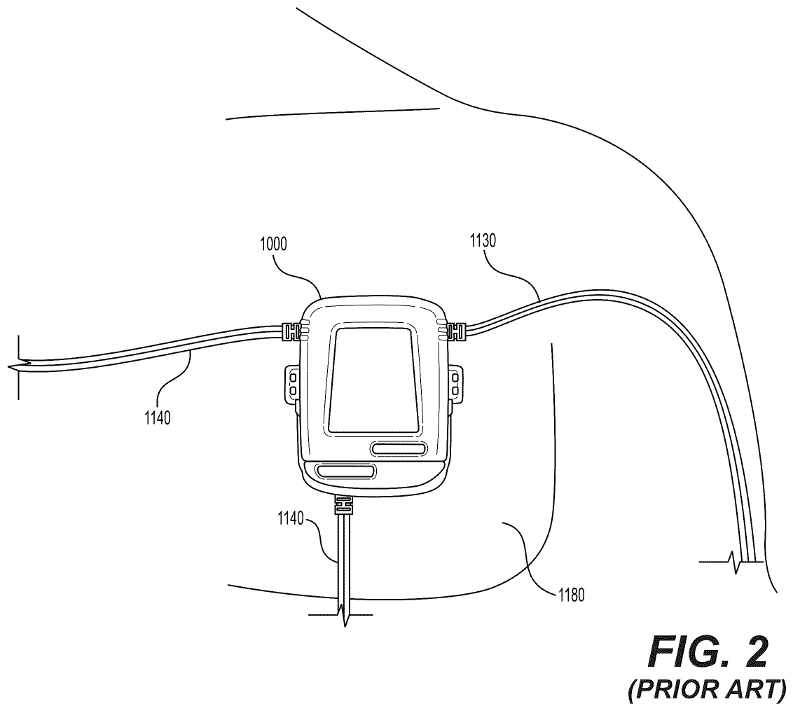

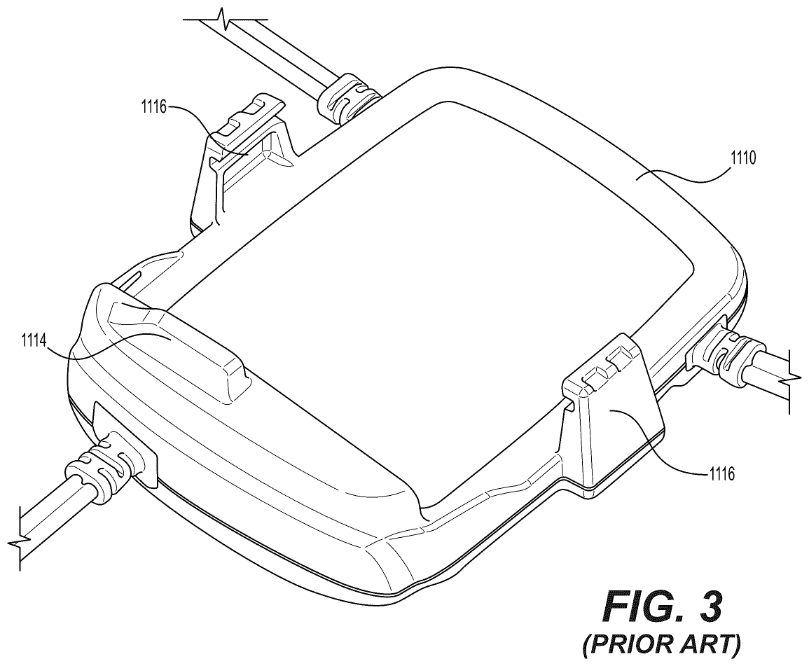

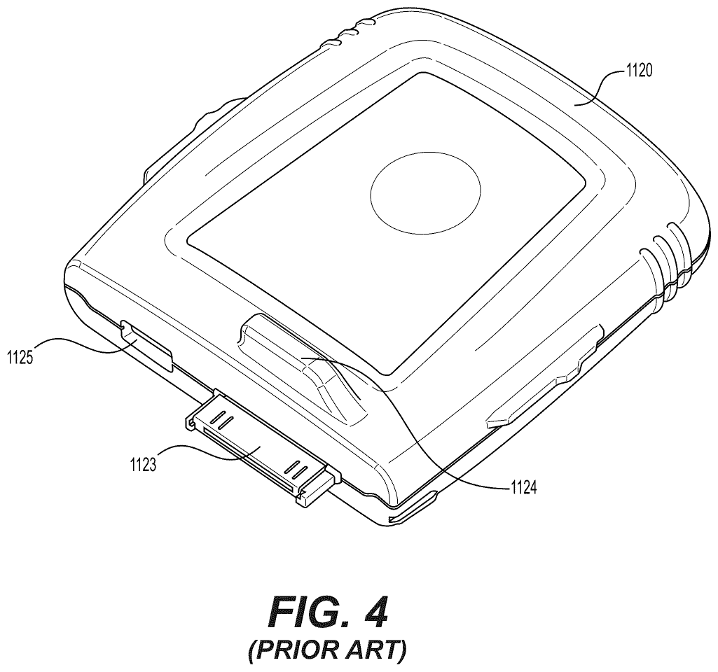

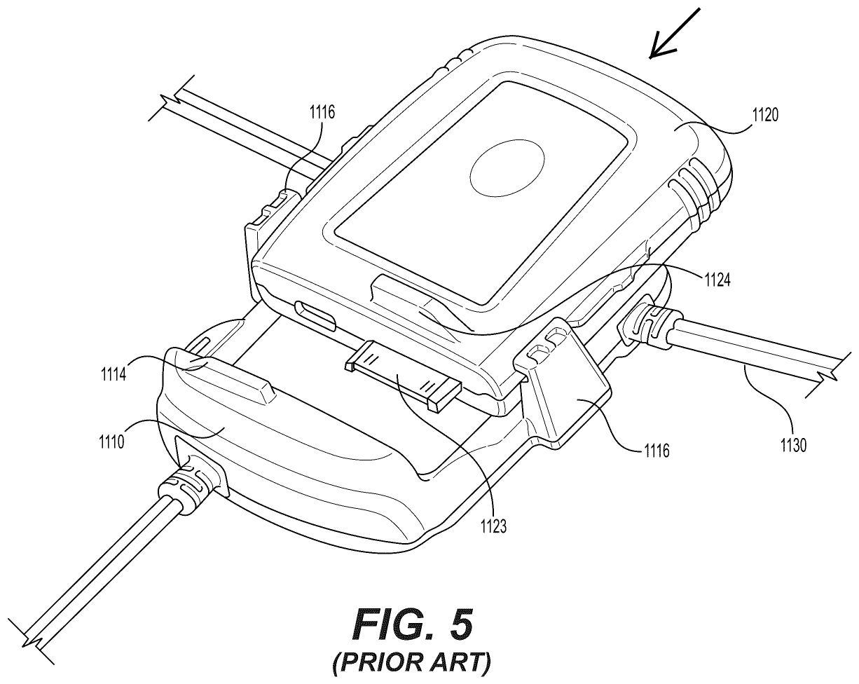

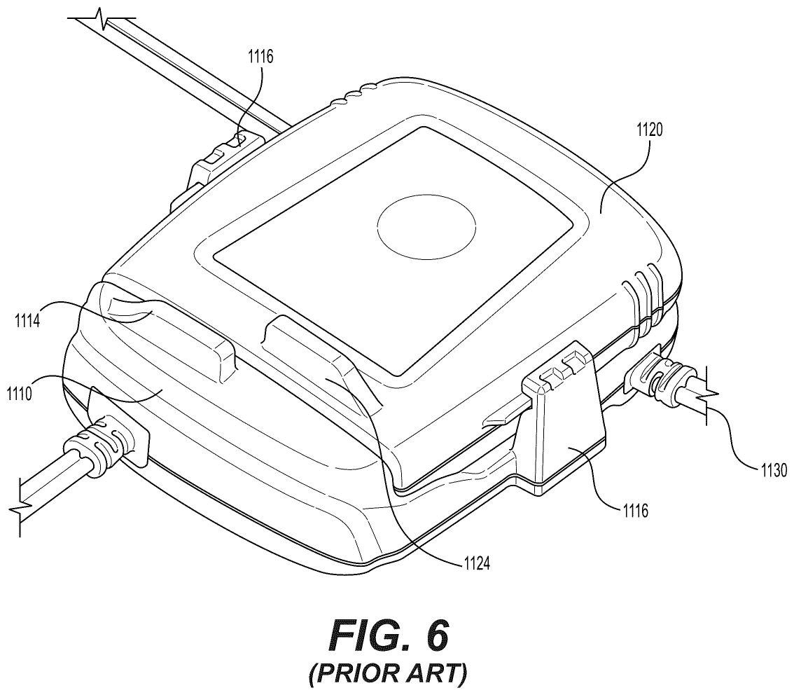

### DETAILED DESCRIPTION OF PREFERRED EMBODIMENTS

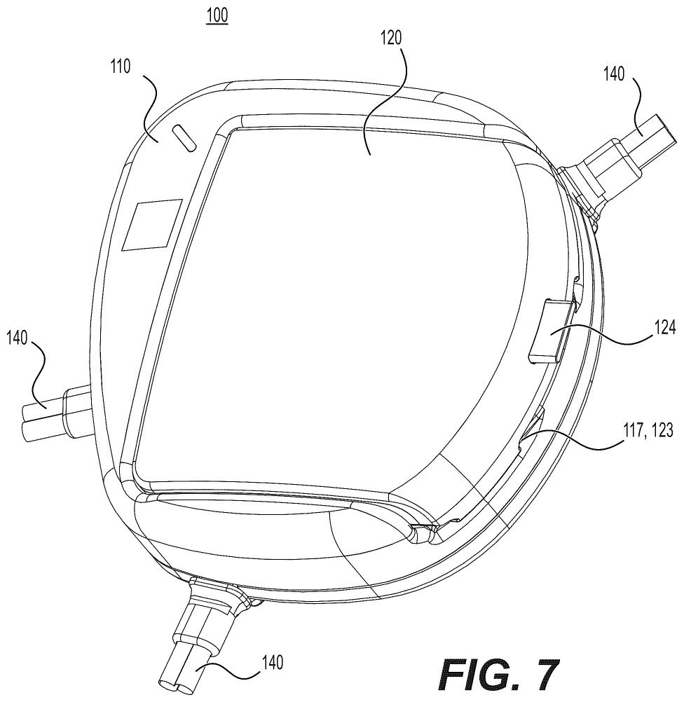

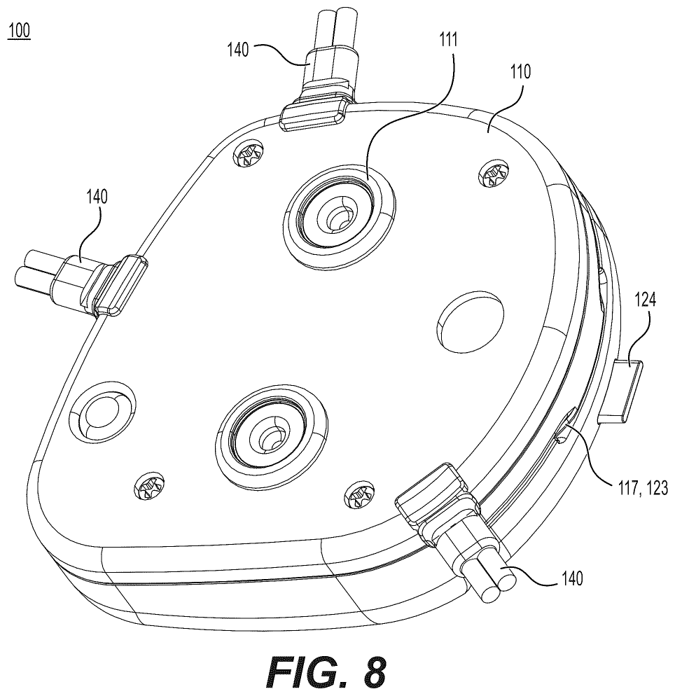

FIGS. 7 and 8 show a patient monitoring device 100 that protects electrical connections from water intrusion and corrosion. In the example of the patient monitoring device 100 shown in FIGS. 7 and 8, a chest device 110 of the patient monitoring device 100 can be attached to the chest of a patient. However, the patient monitoring device 100 can be attached to one or more other areas on the patient's body. The patient monitoring device 100 can detect, record, store, and transmit various vital signs and other information of the patient. For example, the patient monitoring device 100 can include several adherent electrodes that connect to snaps 111 on the rear of the patient monitoring device 100 and that contact the patient's skin to measure various biological information, vital signs, and patient information including, but not limited to, heart rhythm, heart rate, blood pressure, body temperature, respiratory rate, blood oxygenation, blood glucose level, hydration levels, perspiration, and bio-impedance. The patient monitoring device 100 can also track patient motion, movement, activity, position, posture, and physical location.

The patient monitoring device 100 can also communicate with one or more other computing devices, either through wired or wireless communication. For example, the patient monitoring device 100 can use Bluetooth, Wi-Fi, or a cellular communication protocol to communicate with other computing devices such as bedside monitors, personal computers, tablet devices, mobile phones, central servers, or a cloud-based network. As an example, the patient monitoring device 100 can transmit vital-sign information collected from the patient to a tablet device or a personal computer that operates as a bedside monitor. The tablet or personal computer can process received information and display the information in a readily understandable format to a caretaker or other user. For example, a tablet device can receive vital-sign information from the patient monitoring device 100 through a Bluetooth connection and display an electrocardiogram (ECG) waveform of the patient, as well as information on the patient's heart rate, respiration rate, blood oxygenation level, body temperature, and/or other vital signs. As another example, the patient monitoring device 100 can be periodically connected to a computing device (such as a bedside monitor) through a wired connection to allow information collected by the patient monitoring device 100 to be stored, processed, and displayed by the computing device and/or transferred to one or more other computing devices (e.g., personal computers, servers located at the hospital, cloud storage servers, etc.).

Furthermore, information recorded by the patient monitoring device 100 can be transmitted to other computing devices to provide real-time or near real-time analysis of the patient's condition, and to provide tracking of vital-sign information of the patient over time. For example, the information recorded by the patient monitoring device 100 can be transmitted to a display device to allow caregivers to observe the information and adjust patient care based on the information. The information can also be transmitted to a central information repository to log and store historical vital-sign and other information of the patient. Both real-time and historical vital-sign information, and other information, of a patient can be accessed by caregivers who are not at the same physical location as the patient. For example, vital-sign information collected by the patient monitoring device 100 can be transmitted to a mobile device owned by the patient or caregiver (e.g., a smart phone) to allow the patient or caregiver to view the information. The information can further be transmitted to a central server that can be accessed by one or more caregivers (e.g., using personal computers or mobile devices) to allow the caregivers to view the collected information and make patient care decisions for the patient from a location that is remote from where the patient is located.

Other components that can be included as part of the patient monitoring device 100 include a power supply, buttons, or other input mechanisms for receiving user input, one or more audible alarms or speakers, and lights or a display screen. The patient monitoring device 100 can further include input mechanisms such as, for example, buttons, keys, or a touch screen. The input mechanisms can allow the patient or a caregiver to adjust settings for the patient monitoring device 100, perform various tests (for example, sensor tests, battery power level tests, etc.), or reset one or more alarms for the patient monitoring device 100. The input mechanisms can also allow the patient to place a distress call (e.g., to a caregiver or to a hospital alert system) if the patient needs assistance.

As shown in FIGS. 7 and 8, the patient monitoring device 100 can include a chest device 110 connected to a patient, a battery pack 120 to provide power to the chest device 110, and cables 140 each connected to different sides of the chest device 110 that attach signal leads to the chest device 110. The cables 140 can include, for example, ECG cables and pulse ox cables. The battery pack 120 can include standard disposable batteries or a rechargeable battery, and the battery pack 120 is removable such that it can be replaced with a different battery pack.

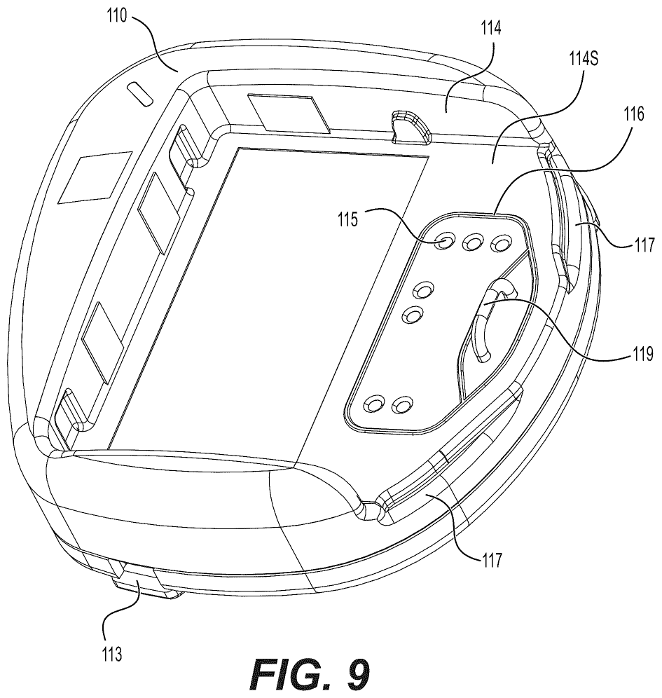

FIG. 9 shows that the chest device 110 includes a recess 114 to receive the battery pack 120. The battery pack 120 is removeable from the chest device 110, i.e., the battery pack 120 can be connected to and disconnected from the chest device 110. The recess 114 defines a recessed surface 114S of the chest device 110, and the recessed surface 114S can be flat or substantially flat so that the recessed surface 114S is able to be easily cleaned by a user.

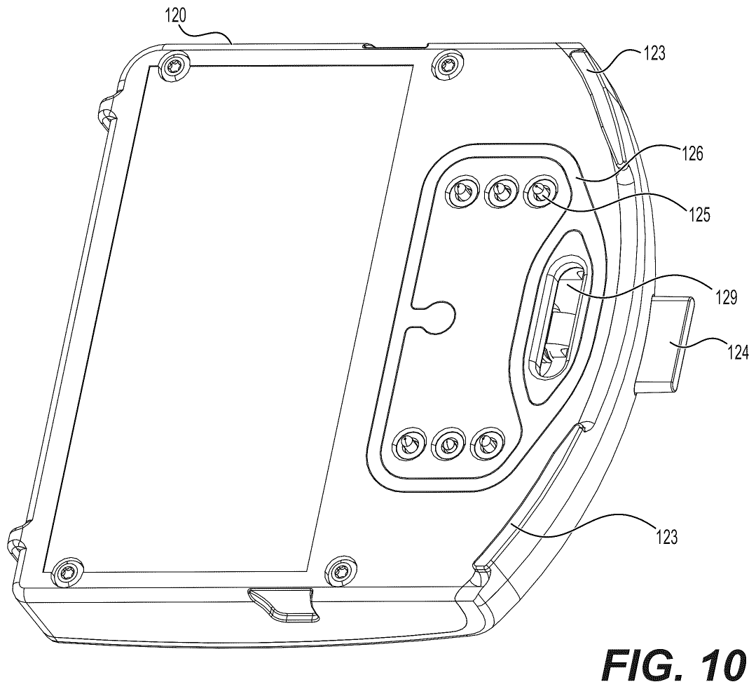

FIG. 10 shows a bottom perspective view of the battery pack 120. The battery pack 120 makes electrical connection with the chest device 110 via a connector system including chest device connectors 115 and battery pack connectors 125, which are electrical connectors that are described in more detail below.

External features of the chest device 110 are described with respect to FIGS. 7-9. The chest device 110 can be made from a clam-shell type construction in which a top housing is attached to a bottom housing, the interior of which houses electronic circuitry to perform patient monitoring and communication operations. FIG. 9 shows that the chest device 110 can include openings 113 through which the cables 140 can be attached to the chest device 110. The openings 113 can all have identical shapes or can have different shapes. If a cable or component is not needed, then a plug (not shown) can be inserted in the corresponding opening 113. The plug can be a permanent plug inserted during a manufacturing or assembly process of the chest device 110, or can be a removable plug that is able to be inserted or removed as needed. For example, a customized chest device 110 with a customized cable combination can be made by replacing an unwanted cable with a plug to close the opening 113 during the manufacturing or assembly process. If the openings 113 have identical shapes, then different shaped plugs do not have to be prepared in the manufacturing or assembly process.

As shown in FIGS. 9 and 10, the chest device 110 and the battery pack 120 include respective electrical connections that are able to be mated and unmated. In particular, the chest device 110 includes chest device connectors 115 provided in recess 114, and the battery pack 120 includes battery pack connectors 125. The chest device connectors 115 can be electrical targets (for example, pogo targets), and the battery pack connectors 125 can be electrical pins (for example, movable pins such as pogo pins). The battery pack connectors 125 can be movable pins that have a direction of motion perpendicular to the recessed surface 114S of the chest device 110 when the battery pack 120 is mated to the chest device 110.

The arrangement and location of the chest device connectors 115 and battery pack connectors 125 are not limited to the specific arrangement and location of chest device connectors 115 and battery pack connectors 125 shown in FIGS. 9 and 10. As an example, the chest device 110 may be provided with pogo pins and the battery pack 120 may be provided with pogo targets. However, the chest device 110 can be designed to have a longer life cycle than the battery pack 120, and thus the chest device connectors 115 can be pogo targets since pogo targets generally have longer life cycles than pogo pins.

The chest device 110 can include chest device connectors 115 that do not mate with battery pack connectors 125 of the battery pack 120. For example, one or more of the chest device connectors 115 can be a data connection for a computer or similar device to perform debugging, maintenance, and the like on the chest device 110. Similarly, the battery pack 120 can include battery pack connectors 125 that do not mate with chest device connectors 115 of the chest device 110. For example, one or more of the battery pack connectors 125 can be a data connection to provide temperature data from a thermistor while a battery of the battery pack 120 is being charged, for example, by a charging station 200 as discussed further below.

For example, the chest device connectors 115 can be separated from one another by at least about 2 mm within manufacturing and measurement tolerances, and the battery pack connectors 125 can be separated from one another by at least about 2 mm within manufacturing and measurement tolerances. Accordingly, corrosion the chest device connectors 115 and the battery pack connectors 125 are further able to be significantly reduced or prevented even if water or other fluids intrude upon the chest device connectors 115 and the battery pack connectors 125.

The chest device connectors 115 and the battery pack connectors 125 each can include a metal or metal coating that is resistant to corrosion. For example, the chest device connectors 115 and the battery pack connectors 125 can include stainless steel or can be plated by nickel or gold.

As shown in FIGS. 7-10, the battery pack 120 can include protrusions or lips 123 that are received by corresponding indents 117 of the chest device 110. The protrusions 123 each can extend higher than an uppermost portion of each of the battery pack connectors 125, with respect to the orientation shown in FIG. 13. Accordingly, when the battery pack 120 is separated from the chest device 110, the battery pack connectors 125 are unlikely to be scratched or corroded, for example, by a user placing the battery pack 120 on a desk surface with the battery pack connectors 125 facing the desk surface.

The chest device 110 includes a ridge 116 that surrounds the chest device connectors 115, and as shown in FIG. 10, the battery pack 120 includes a gasket 126 that surrounds the battery pack connectors 125. The ridge 116 and the gasket 126 can have corresponding and similar shapes. However, the gasket 126 can be wider than the ridge 116 to ensure that the ridge 116 is fully engaged and surrounded by the gasket 126. The gasket 126 can include additional material (e.g., protrusions) due to an injection molding process used to form the gasket 126, and/or to help secure the gasket 126 to the battery pack 120.

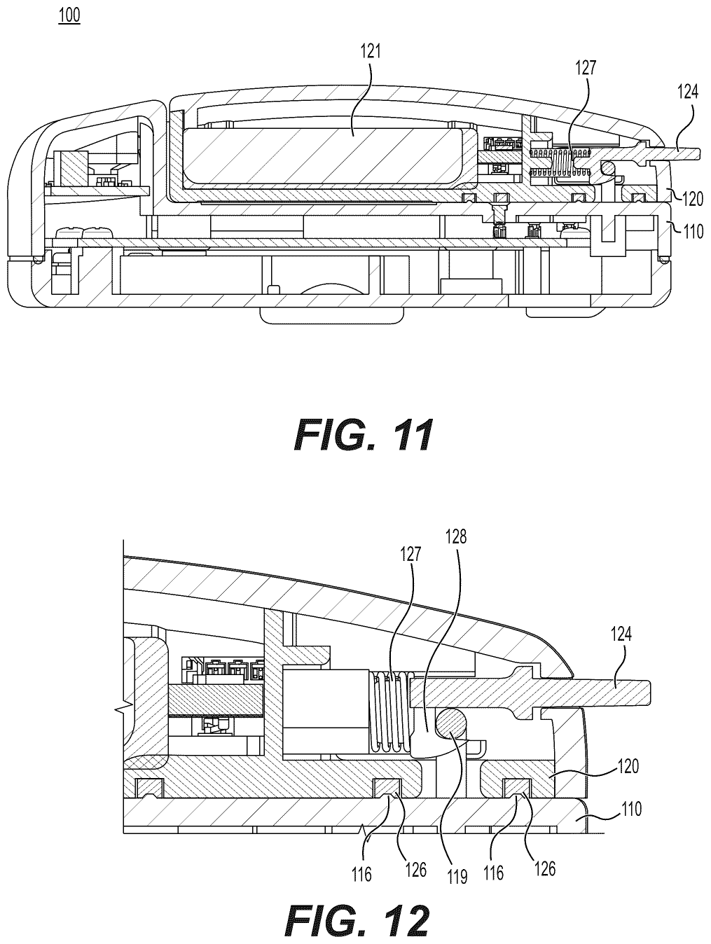

FIG. 11 shows a cross-sectional view of the patient monitoring device 100, and FIG. 12 shows an enlarged portion of the cross-sectional view shown in FIG. 11. As shown in FIG. 12, the ridge 116 of the chest device 110 engages with and compresses the gasket 126 of the battery pack 120. Accordingly, the ridge 116 and the gasket 126 provide water resistance or water tightness to a portion of the patient monitoring device 100 where the chest device connectors 115 mate with the battery pack connectors 125. Thus, water or other fluids that might splash upon the patient monitoring device 100 (for example, in a case that a patient accidentally wears the patient monitoring device 100 while showering or in a case that a patient spills liquid on the patient monitoring device 100) are able to be significantly reduced or prevented from intruding on the electrical connections between the chest device 110 and the battery pack 120. Accordingly, corrosion of the chest device connectors 115 and the battery pack connectors 125 is able to be significantly reduced or prevented. The battery pack 120 can also include internal circuitry or the like to prevent a short circuit condition between the battery pack connectors 125, for example, if water or other fluids are spilled on the battery pack 120 while the battery pack 120 is not connected to the chest device 110. That is, the battery pack connectors 125 can be disconnected from the battery in the battery pack 120 unless the battery pack 120 is connected to the chest device 110 or a charging station, for example, charging station 200 discussed further below. For example, the battery pack 120 can provide a voltage only when a first group of the battery pack connectors 125 is connected to the chest device 110, and the battery pack can charge the battery only when a second group of the battery pack connectors 125 is connected to a charging station, for example, charging station 200 discussed further below. The second group of the battery pack connectors 125 can be the same as the first group of the battery pack connectors 125.

A lock structure of the chest device 110 and the battery pack 120 is described below with respect to FIGS. 9 to 12. As shown in FIGS. 9 and 10, the chest device 110 includes a loop 119 that is received by an opening 129 in the battery pack 120. As shown in FIGS. 11 and 12, the battery pack 120 further includes a hook or latch 128 that engages with the loop 119 of the chest device 110 when the loop 119 is inserted into the opening 129. The hook 128 engages with a spring 127 that presses the hook 128 against the loop 119 to support, lock, and retain the battery pack 120 to the chest device 110. The hook 128 is also rigidly connected to a button 124 that protrudes from the housing of the battery pack 120. A user can press the button 124 to compress the spring 127 and disengage the hook 128 from the loop 119, thereby enabling the battery pack 120 to be unmated from the chest device 110. A secondary gasket (not shown), for example, an O-ring, can also be provided on a portion of the button 124 between the housing of the battery pack 120 and the button 124 to significantly reduce or prevent water or other fluids from intruding into the interior of the battery pack 120. An additional or alternative secondary gasket (not shown) can be provided with the chest device 110, for example, that is able to be inserted with the loop 119 into the opening 129 of the battery pack 120.

The chest device 110 does not need to be disconnected or discarded to change or modify the battery pack 120. With a removable battery pack 120, the chest device 110 can remain attached to the patient and does not need to be removed from the electrodes connected to the cables 140. If rechargeable, the battery pack 120, when depleted, can be replaced with a charged battery pack while the chest device 110 remains attached to the patient. If the battery charge of the battery pack 120 reduces too much or the batteries deteriorate after many times of charging and discharging, a user can simply replace the old battery pack 120 with a new one, without having to replace the chest device 110 that is relatively more expensive than the battery pack 120 because of the circuitry included in the chest device 110.

FIGS. 13 and 14 show perspective views of internal components of the chest device 110 and the battery pack 120. A battery 121 of the battery pack 120 can be either a replaceable battery or a rechargeable battery. If the battery pack 120 includes a rechargeable battery, then the battery pack 120 can be charged using a charging station 200, as explained below. As an example, the battery 121 can be a lithium-ion battery that has a voltage of between about 4.0 V and 4.2 V.

As shown in FIG. 13, the battery pack 120 can include a battery 121 and a battery PCB 122. The battery PCB 122 routes power and electrical signal interconnections between the battery 121 and the battery pack connectors 125. The battery PCB 122 can be rigid or flexible and can include circuitry components. Although the circuitry components can include circuitry components that are not related to battery functions (e.g., functions related to the chest device 110), the battery pack 120 can only include circuitry components related to battery functions (e.g., charging, battery status, short circuit protection, and the like). Optionally, the power and electrical signals can be routed by discrete wires or another suitable mechanism. According to the arrangement shown in FIGS. 9-12, the battery pack 120 can change without affecting the chest device 110. That is, the battery pack 120 can vary in thickness to accommodate a different battery that can have a longer life or be made with a different battery technology without having to redesign or reconfigure the chest device 110.

As shown in FIGS. 13 and 14, the chest device 110 can include a PCB 112A that is located to not overlap a battery 121 included in a battery pack 120, in plan view, i.e., in a direction perpendicular to a major surface of the PCB 112A or in a direction towards the patient when the chest device 110 is attached to a patient. Accordingly, the first PCB 112A can include circuitry to provide wireless communication and the like. The chest device 110 can further include a second PCB 112B. The first PCB 112A and the second PCB 112B can include mounted circuitry components. In addition, the first PCB 112A and the second PCB 112B can be rigid and made from any suitable material. However, any suitable substrate can be used instead of the first PCB 112A and the second PCB 112B.

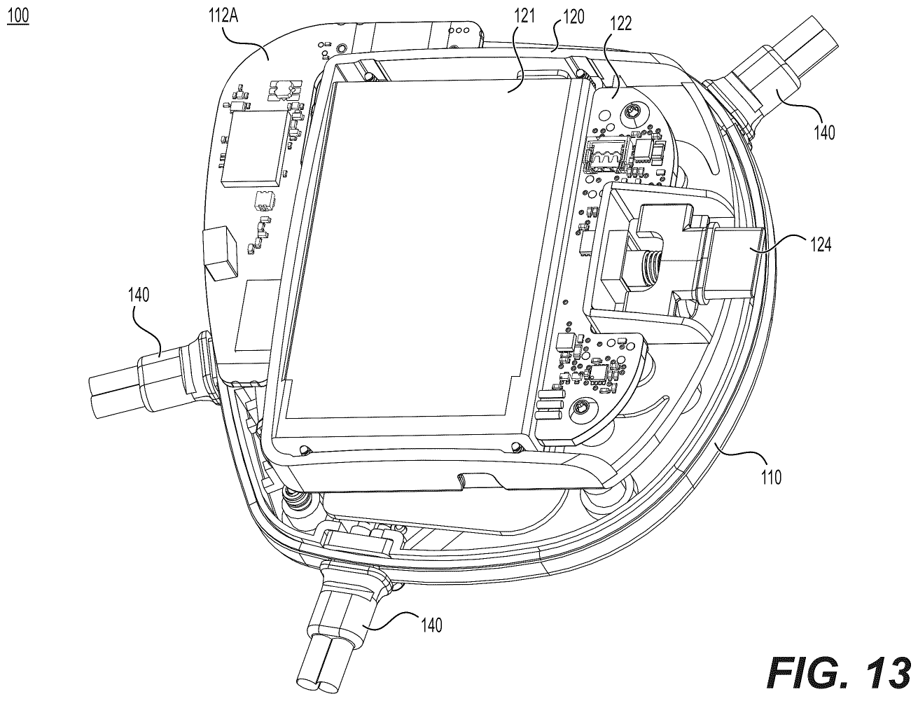

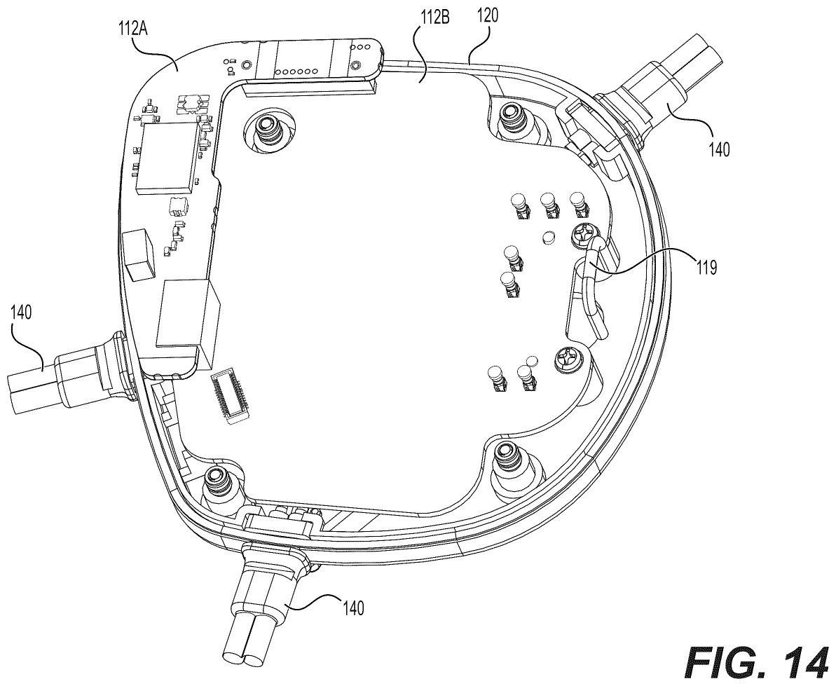

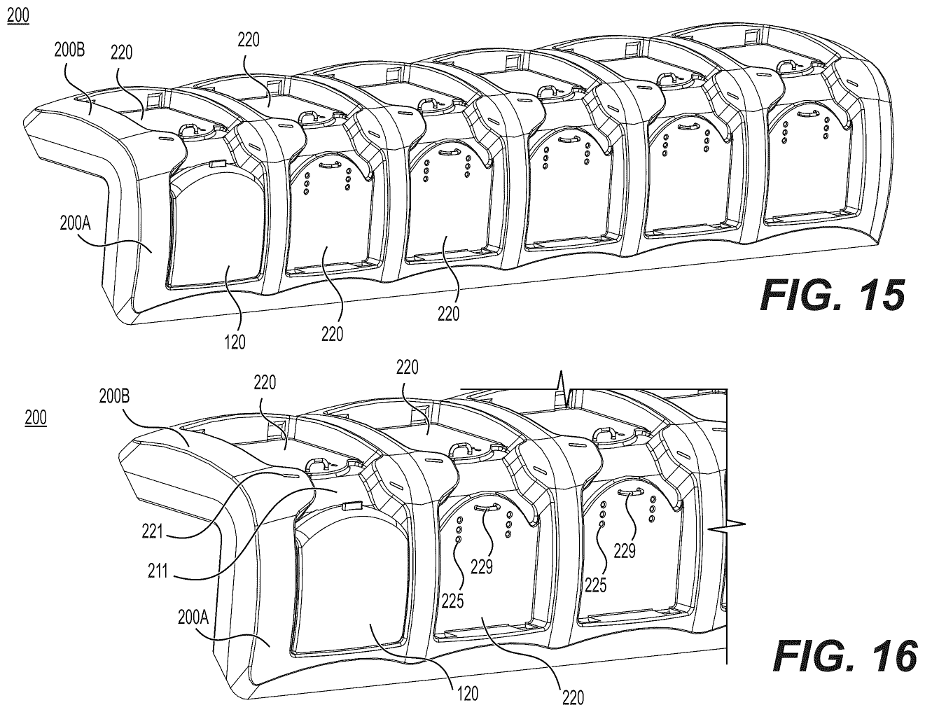

FIGS. 15 and 16 show a charging station 200 that can be used with the battery pack 120 shown in FIG. 10. The charging station 200 includes a housing that is generally provided in a V-shape that enables the charging station 200 to be easily placed upon a desk or other surface. However, as will be explained below, the charging station 200 can also be easily mounted to a wall or the like. In addition, the vertex of the V-shape may be provided with a hinge or the like so that an angle between the respective primary surfaces 200A and 200B of the charging station 200 can be changed.

As shown in FIG. 15, one or more battery packs 120 can be received by the charging station 200 in respective bays 220 of the charging station 200. Each of the bays 220 is defined by a recess in the housing of the charging station 200, and the bays 220 can be provided in two rows on the respective primary surfaces 200A and 200B of the charging station 200.

As shown in FIG. 16, each of the bays 220 includes charging connectors 225 that provide electrical connections for the battery packs 120. The charging connectors 225 are similar to the chest device connectors 115 of the chest device 110. The charging connectors 225 can be electrical targets (for example, pogo targets) and the battery pack connectors 125 are electrical pins (for example, movable pins such as pogo pins). The battery pack connectors 125 can be movable pins that have a direction of motion perpendicular or substantially perpendicular to a respective one of the primary surfaces 200A and 200B of the charging station 200 when the battery pack 120 is mated to the corresponding bay 220.

The specific arrangement and location of the charging connectors 225 and the battery pack connectors 125 are not limited to the specific arrangement and location of the charging connectors 225 and the battery pack connectors 125 shown in the drawings. As an example, the bays 220 of the charging station 200 may be provided with pogo pins and the battery pack 120 may be provided with pogo targets. However, the charging station 200 can be designed to have a longer life cycle than the battery pack 120, and thus the charging connectors 225 can be pogo targets since pogo targets generally have longer life cycles than pogo pins.

The charging station 200 can include one or more charging status indicators 221, as shown in FIG. 16. A single charging status indicator 221 can be provided for each of the bays 220 to provide a visual indication to a user to easily observe a charging status of each battery pack 120 provided in one of the bays 220. Each of the charging status indicators 221 can include a light pipe that routes light received from a light-emitting diode, for example.

For example, the charging connectors 225 can be separated from one another by at least about 2 mm within manufacturing and measurement tolerances, and the battery pack connectors 125 are separated from one another by at least about 2 mm within manufacturing and measurement tolerances.

The charging connectors 225 and the battery pack connectors 125 each can include a metal or metal coating that is resistant to corrosion. For example, the charging connectors 225 and the battery pack connectors 125 can include stainless steel or can be plated by nickel or gold.

The battery pack 120 can also include internal circuitry or the like to prevent a short circuit condition between the battery pack connectors 125, for example, if water or other fluids are spilled on the battery pack 120 when the battery pack 120 is not connected to the chest device 110 or the charging station 200. That is, the battery pack connectors 125 can be disconnected from the battery in the battery pack 120 unless the battery pack 120 is connected to the chest device 110 or the charging station 200. For example, the battery pack 120 can provide a voltage only when a first group of the battery pack connectors 125 is connected to the chest device 110, and the battery pack can charge the battery only when a second group of the battery pack connectors 125 is connected to the charging station 200. The second group of the battery pack connectors 125 can be the same as the first group of the battery pack connectors 125. In addition, one or more of the battery pack connectors 125 can be a data connection to provide temperature data from a thermistor when a battery of the battery pack 120 is being charged by the charging station 200.

As shown in FIG. 16, each of the bays 220 can include a loop 229. The loop 229 is similar to the loop 119 of the chest device 110, such that the hook 128 of one of the battery packs 120 engages with a corresponding loop 229 of the charging station 200 while the battery pack 120 is being charged. A user is able to press the button 124 on the battery pack 120 to compress the spring 127 and disengage the hook 128 from the corresponding loop 229, thereby enabling the battery pack 120 to be unmated from the charging station 200. In addition, an opening 211 can be provided at the vertex of the V-shape of the charging station 200 that connects two opposing bays 220 to enable a user to easily insert his or her finger to remove the battery pack 120 from either of the two opposing bays 220. The opening 211 can be shared between adjacent bays 220 provided on the respective primary surfaces 200A and 200B of the charging station 200.

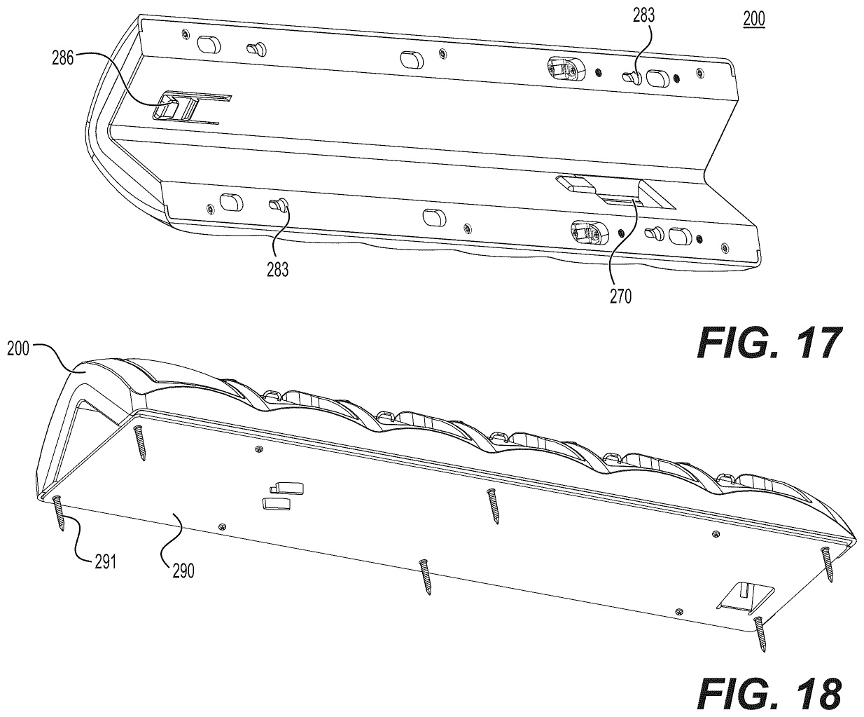

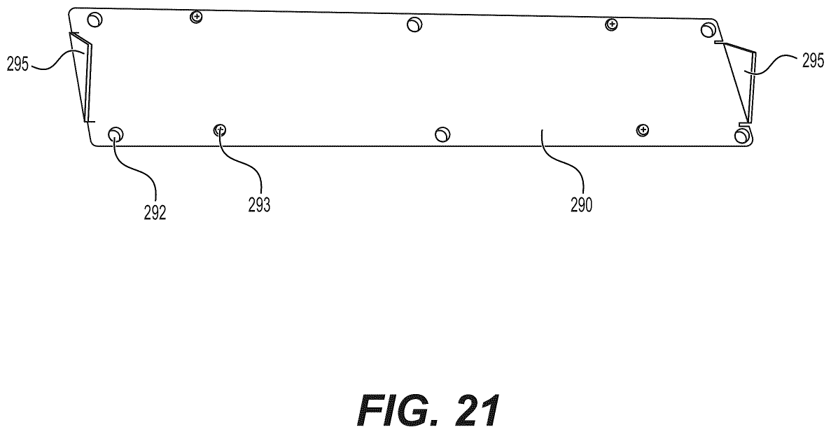

FIG. 17 shows a bottom perspective view of the charging station 200, and FIG. 18 shows a mounting bracket 290 that can be included with the charging station 200. As shown in FIG. 17, the charging station 200 can include keyholes 283 that receive corresponding shoulder screws or nobs 293 of the mounting bracket 290 (shown in FIG. 21, as discussed below) to secure the mounting bracket 290 to the charging station 200. FIG. 17 also shows that the charging station 200 can include a spring latch 286 and a power port 270.

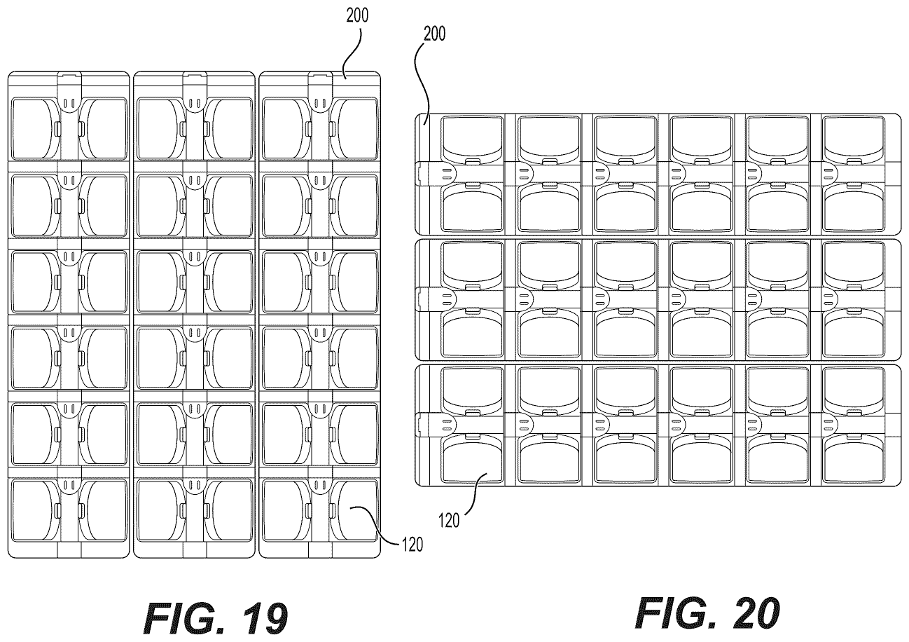

As shown in FIG. 18, mounting screws 291 can securely hold the charging station 200 to a wall or the like by affixing the mounting bracket 290 to the wall or the like. The mounting bracket 290 can have a relatively flat shape. For example, the mounting bracket 290 can be shaped from a flat sheet of aluminum. Accordingly, a footprint of the charging station 200 when mounted to the wall or the like can be significantly reduced, even when a plurality of charging stations 200 are mounted. FIGS. 19 and 20 show that one or more charging stations 200 can be mounted to the wall or the like in a vertical orientation or a horizontal orientation.

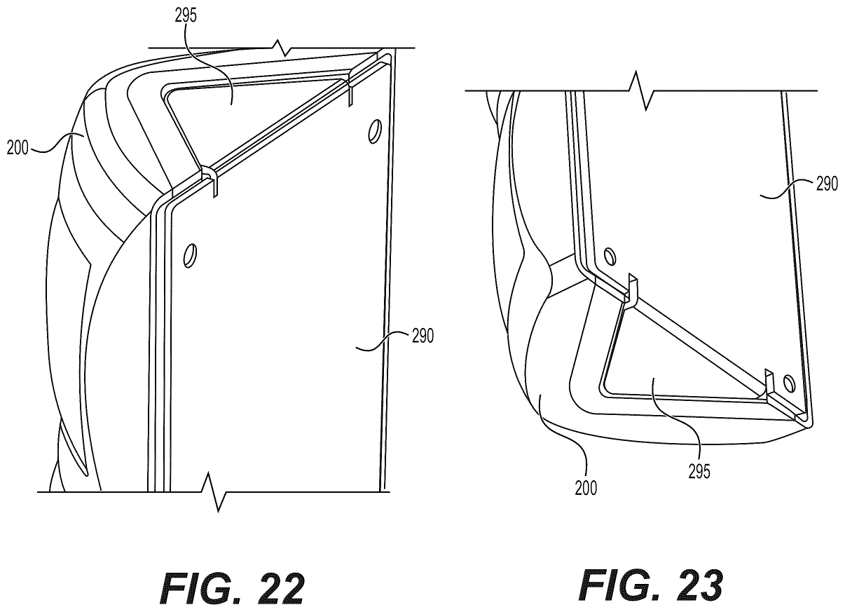

FIG. 21 shows a modification of the mounting bracket 290 to include end caps 295. FIG. 21 also shows the shoulder screws or nobs 293 that can be received by the corresponding keyholes 283 of the charging station 200 and shows the screw holes 292 that receive mounting screws 291 shown in FIG. 18. FIGS. 22 and 23 show close-up views of each of the end caps 295 of the bracket 290. As shown in FIGS. 22 and 23, the mounting bracket 290 can be modified to include end caps 295 to help prevent contaminants from entering a body of the charging station 200.

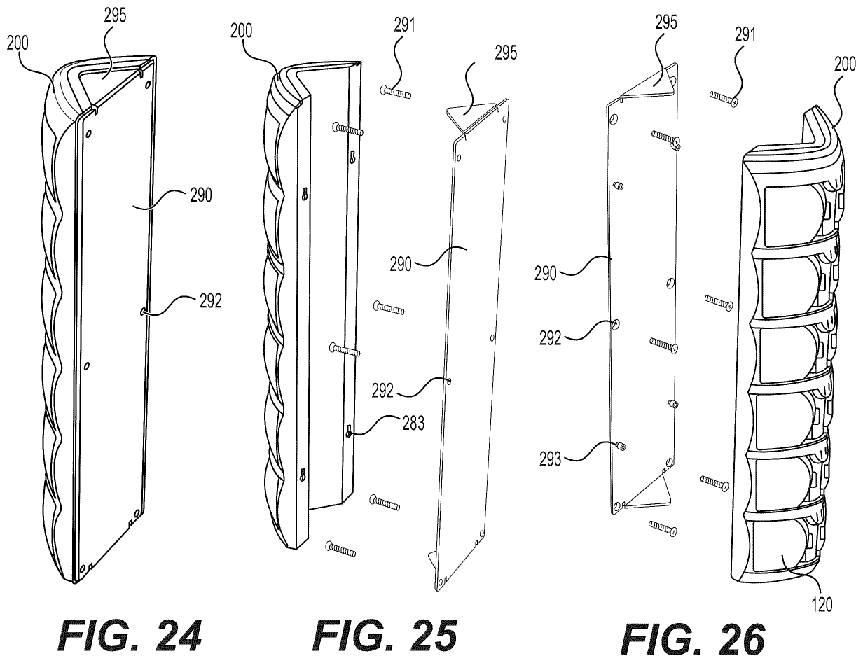

FIGS. 24-26 show an example of mounting the charging station 200 shown in FIG. 15 and the mounting bracket 290 shown in FIG. 21 in a vertical orientation. As shown in FIGS. 24-26, the mounting bracket 290 can be removed from the charging station 200 by separating the shoulder screws or nobs 293 of the mounting bracket 290 from the corresponding keyholes 283 of the charging station 200, for example, by sliding the charging station 200 along the mounting bracket 290 and/or pulling the charging station 200 away from the mounting bracket 290. With the mounting bracket 290 separated from the charging station 200, the mounting screws 291 can be inserted through the corresponding screw holes 292 in the mounting bracket 290 to secure the mounting bracket 290 to a wall or the like. The charging station 200 can then be reattached to the mounting bracket 290 (while the mounting bracket 290 is secured to the wall or the like) by inserting the shoulder screws or nobs 293 of the mounting bracket 290 into the corresponding keyholes 283 of the charging station 200.

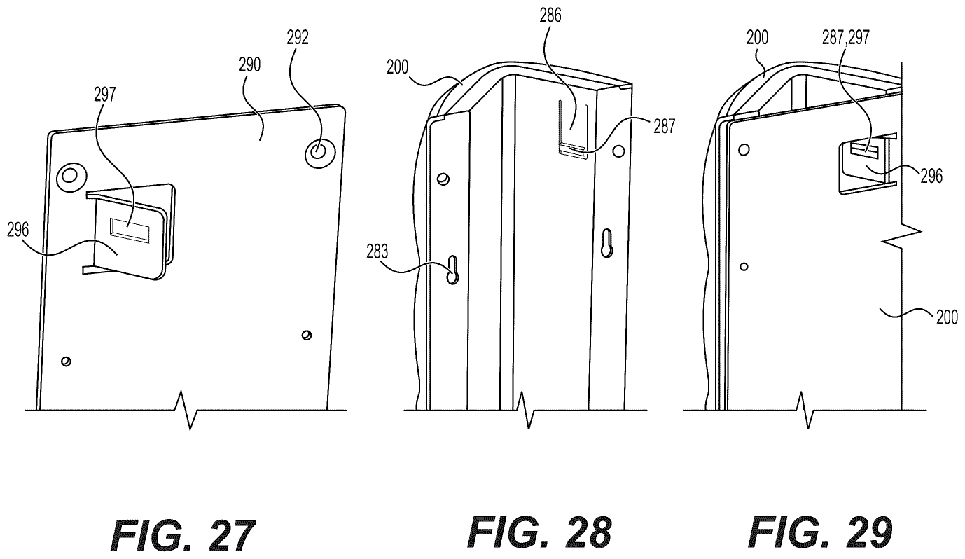

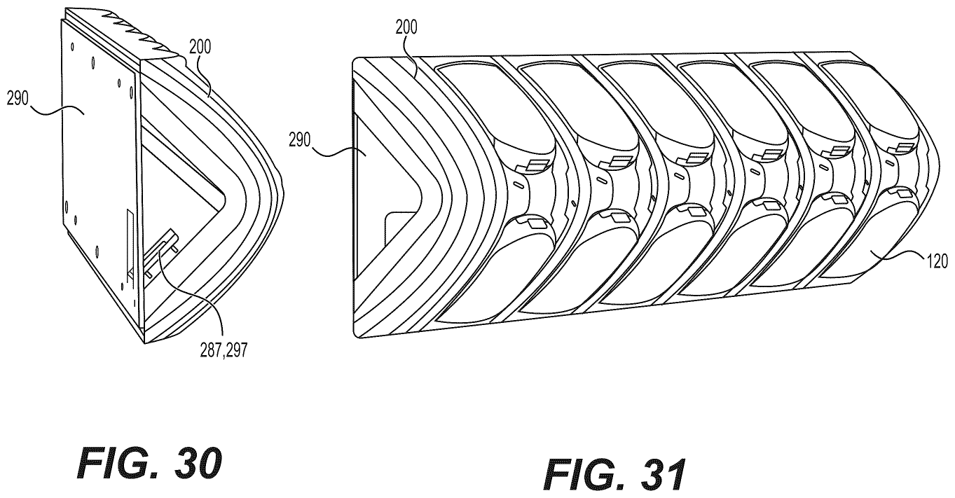

FIGS. 27-31 show an example of a spring latch 286 of the charging station 200 shown in FIG. 15 mating with a folded tab 296 of the mounting bracket 290 shown in FIG. 17. As shown in FIGS. 27 and 28, the folded tab 296 of the mounting bracket 290 includes a tab hole 297, and the spring latch 286 of the charging station 200 includes a raised portion 287. The raised portion 287 can engage with the tab hole 297 to secure the spring latch 286 to the folded tab 296, thereby securing the charging station 200 and the mounting bracket 290 to one another, as shown in FIG. 29. A user can easily detach the mounting bracket 290 from the charging station 200 by depressing the raised portion 287, so that the raised portion 287 does not engage with the tab hole 297, and then sliding the charging station 200 along the mounting bracket 290. The spring latch 286 and the folded tab 296 can be provided in addition to the keyholes 283 and the shoulder screws or nobs 293 described above.

A portion of the spring latch 286, for example, the raised portion 287, can include a high-contrast color or the like to improve visibility to a user when the user attempts to detach the mounting bracket 290 from the charging station 200 or when the user needs to verify that the folded tab 296 and the spring latch 286 are properly mated with one another.

As shown in FIGS. 29-31, when the mounting bracket 290 includes the folded tab 296, the mounting bracket 290 does not have to also include at least one of the end caps 295 shown in FIGS. 21-26. By omitting at least one of the end caps 295, a user is able to easily observe and reach into an interior of the charging station 200 to access the location of the spring latch 286 and the folded tab 296.

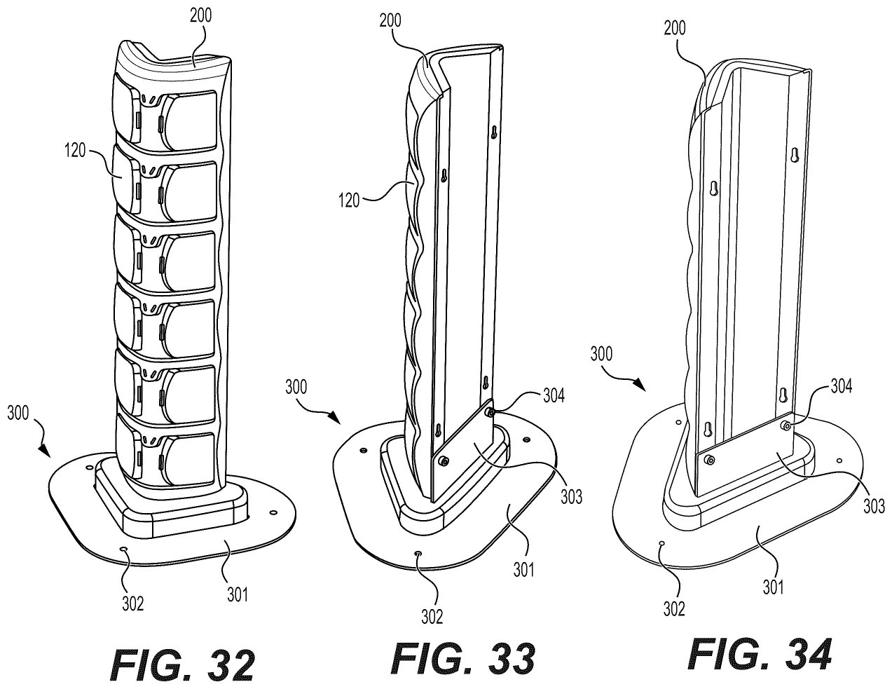

FIGS. 32-34 show a vertical stand 300 for the charging station 200 shown in FIG. 15. The vertical stand 300 includes a base plate 301 that can be placed upon a surface, for example, a desk. The base plate 301 can include base plate holes 302 through which screws or the like are able to be inserted to secure the base plate 301 to the surface. The vertical stand 300 further includes a mounting plate 303 that is positioned to abut the charging station 200 when the vertical stand 300 receives the charging station 200. The charging station 200 can be secured to the vertical stand by mounting plate screws 304.

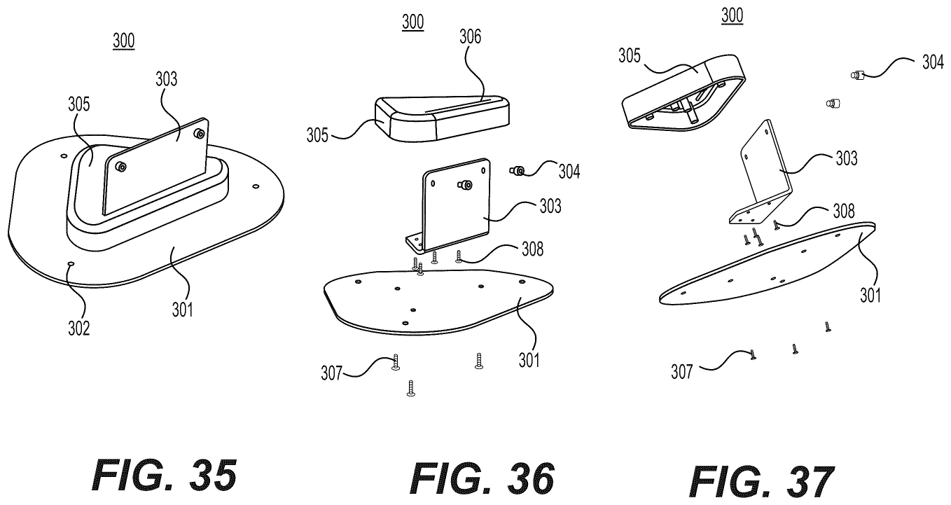

FIGS. 35-37 show views of the vertical stand 300 shown in FIGS. 32-34. The vertical stand 300 includes a base housing 305 with a slot 306 that receives the mounting plate 303, and the base housing 305 can be secured to the base plate 301 by base screws 307. In addition, the mounting plate 303 can be secured to the base housing 305 by housing screws 308. The vertical stand 300 can be provided with the base bae plate 301, the mounting plate 303, and the base housing 305 as three separate components that are secured to one another for ease in manufacturing the vertical stand 300. However, one or more of the base plate 301, the mounting plate 303, and the base housing 305 can be manufactured together as a single component.

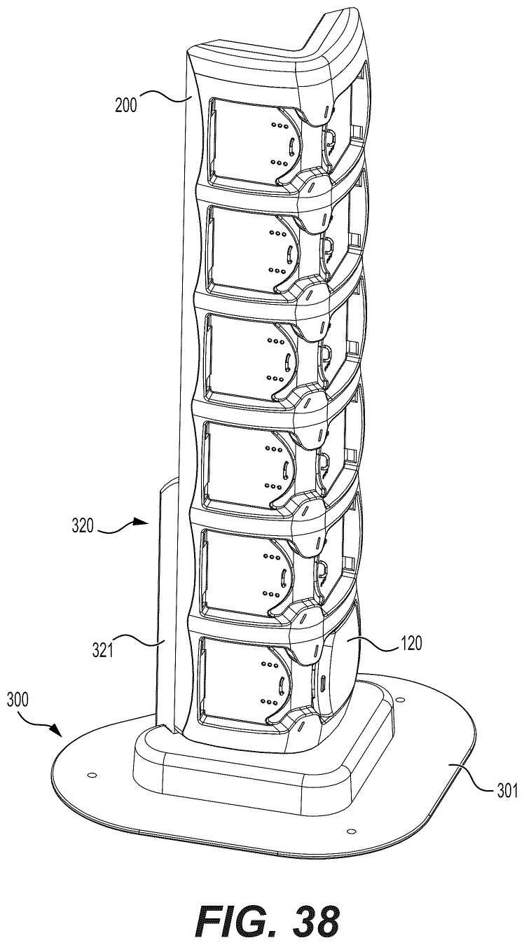

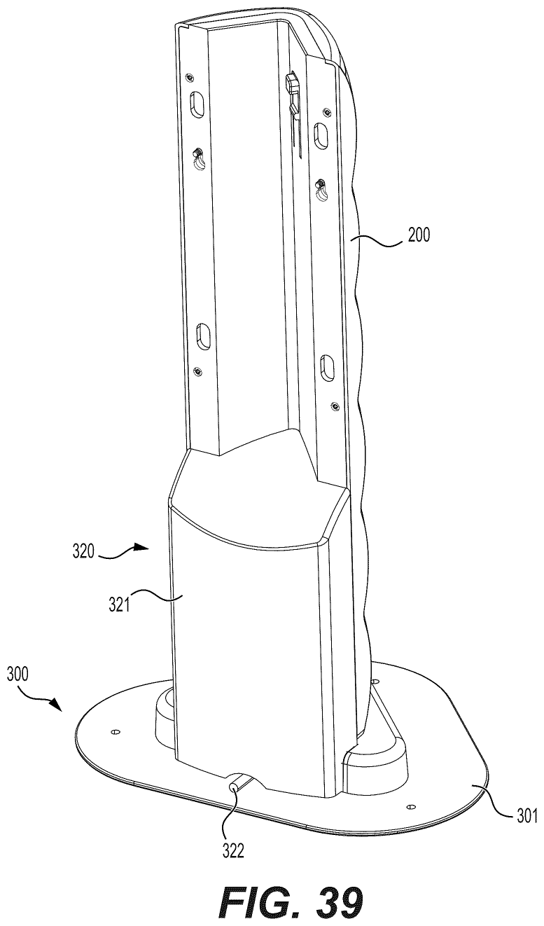

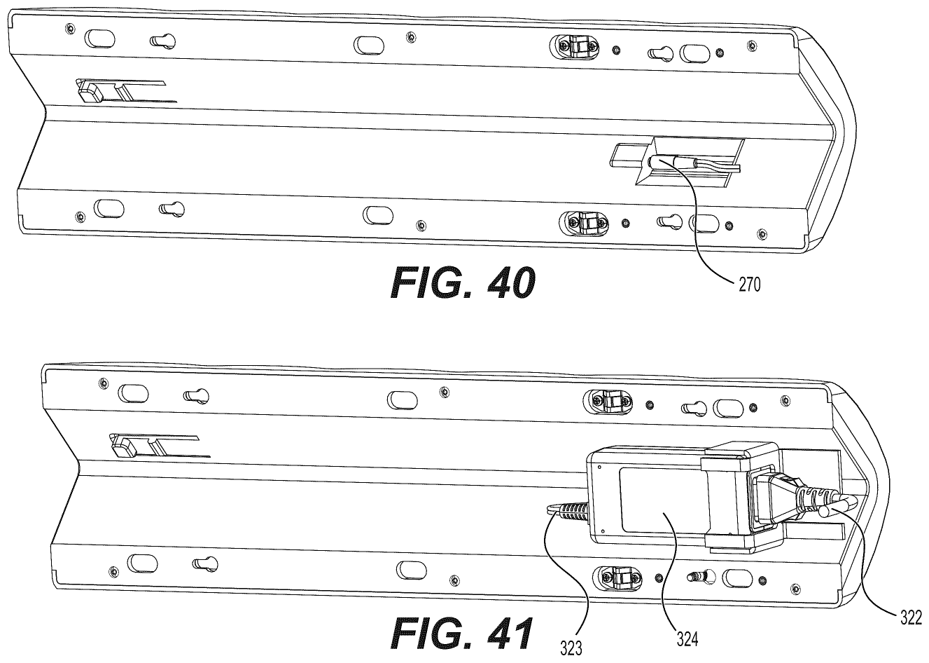

FIGS. 38 and 39 show a power supply 320 included with the vertical mount stand 300 and the charging station 200. FIGS. 40 and 41 show internal views of components for the power supply 320. As shown in FIGS. 38 and 39, the power supply 320 can include a housing 321 that is received by one or both of the vertical mount stand 300 and the charging station 200. As shown in FIGS. 39 and 41, the power supply 320 can include a power plug 323 that can receive electrical power from an external source, for example, a conventional outlet (e.g., a 120 V AC supply).

As shown in FIGS. 40 and 41, the power supply 320 can include a power plug 323 that can be received by the power port 270 of the charging station 200 to provide power to the charging station 200. The power supply 320 can provide a DC voltage (for example, 4.2 V to 5 V DC) to the charging station 200 via the power plug 323. As shown in FIG. 41, the power supply 320 can also include a power converter 324 (for example, an AC-DC converter) to convert a voltage received from the adapter plug 322 (e.g., an AC voltage) to a voltage that can be output to the charging station 200 via the power plug 323 (e.g., a DC voltage).

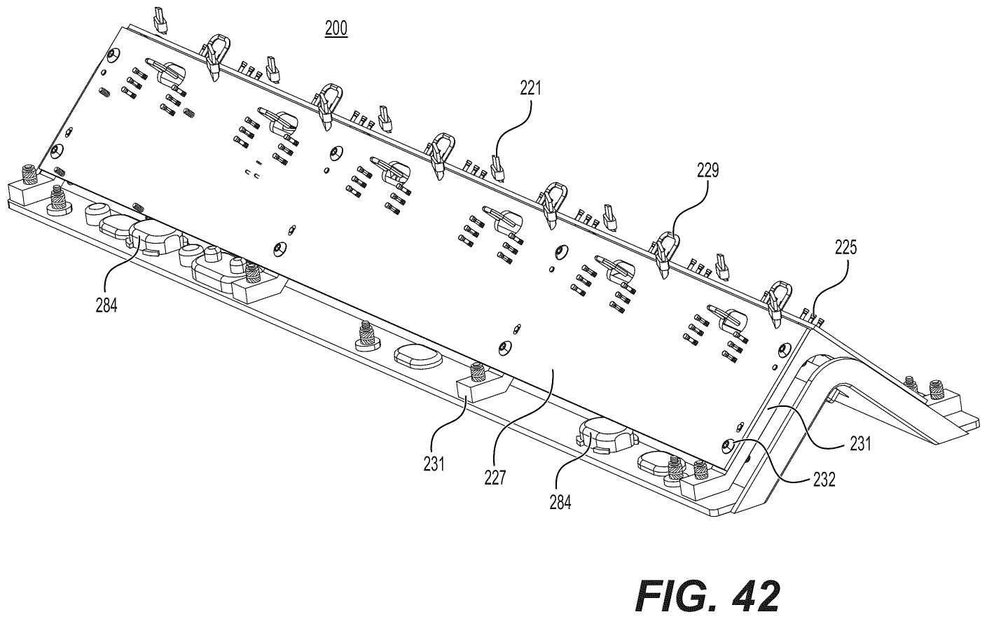

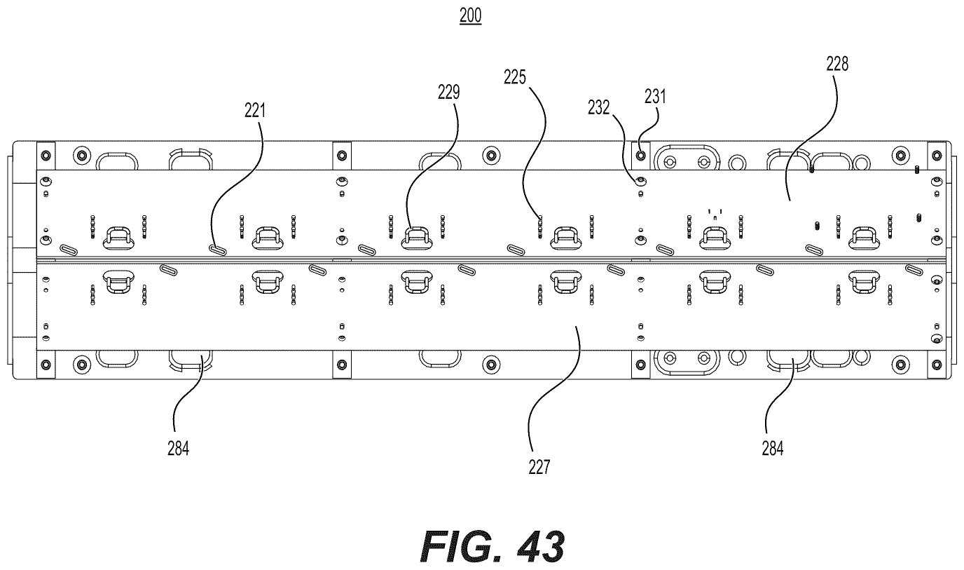

FIGS. 42 and 43 are perspective and top views of internal components of the charging station 200. As shown in FIGS. 42 and 43, the charging station 200 includes the charging status indicators 221, the charging connectors 225, and the loops 229 as described above. The charging station 200 also includes a first substrate 227 and a second substrate 228. The first substrate 227 can supply electric power to each of the bays 220 provided on the primary surface 200A of the charging station 200, and the second substrate 228 can supply electric power to each of the bays 220 provided on the primary surface 200B of the charging station 200. Each of the first substrate 227 and the second substrate 228 can receive electric power from the power supply 320 described above. Light-emitting diodes (not shown) can be provided on each of the first substrate 227 and the second substrate 228 to provide light for the charging status indicators 221.

The charging station 200 can include braces 231, and the first substrate 227 and the second substrate 228 can be mounted to the braces 231 by welds or screws 232 as shown in FIGS. 42 and 43. The first substrate 227 and the second substrate 228 can have the same shape to reduce manufacturing costs.

FIGS. 42 and 43 show that the charging station 200 can include keyhole caps 284 that are provided over the keyholes 283 shown in FIG. 17. The keyhole caps 284 are protective covers that can be provided to significantly reduce or prevent the intrusion contaminants into the interior of the charging station 200 through the openings defined by the keyholes 283.

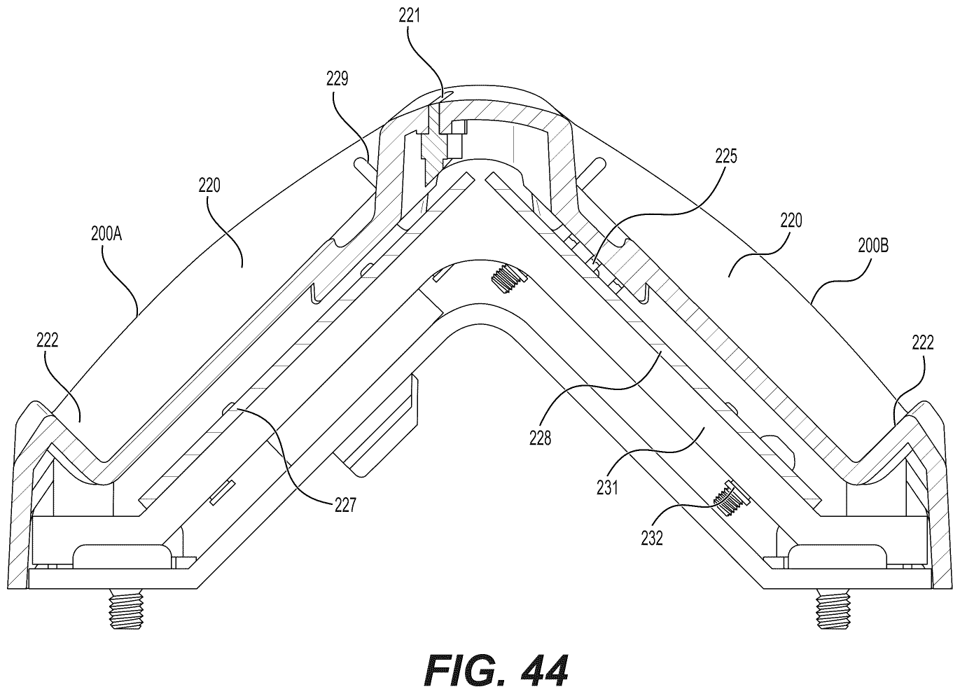

FIG. 44 shows a cross-sectional view of the charging station 200. As shown in FIG. 44, a lower end surface 222 of each of the bays 220 is perpendicular or substantially perpendicular within manufacturing and measurement tolerances to the respective primary surface 200A or 200B, thereby enabling a user to easily remove a battery pack 120 from each of the bays 220, with the battery pack 120 being retained in the respective bay 220 by the loop 229 as described above.

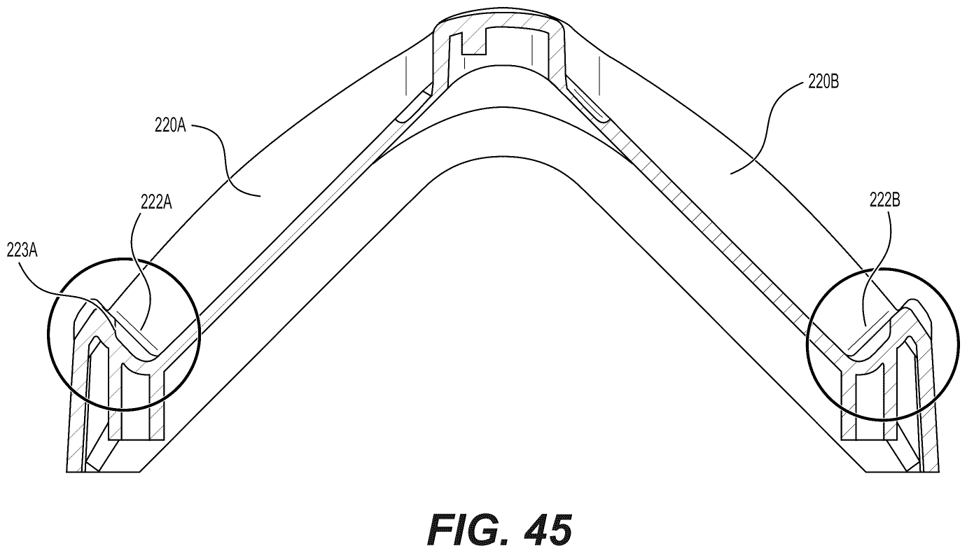

FIG. 45 is a cross-sectional view of modified bays 220A and 220B of the charging station 200. As shown in FIG. 45, lower end surface 222A and 222B of each of the modified bays 220A and 220B includes an undercut that can receive a battery pack to secure the battery pack within the corresponding modified bay 220A and 220B. FIG. 45 further shows that the lower end surface 222A of the modified bay 220A can include a chamfered surface or corner 223A, which can help reduce manufacturing costs.

It should be understood that the foregoing description is only illustrative of the present invention. Various alternatives and modifications can be devised by those skilled in the art without departing from the present invention. Accordingly, the present invention is intended to embrace all such alternatives, modifications, and variances that fall within the scope of the appended claims.

What is claimed is:

1: A charger assembly comprising:
a housing including:
a first surface;
a second surface that is not parallel with the first surface;
a first recess in the first surface;
a second recess in the second surface; and
a first opening connecting the first recess and the second recess;
a first group of electrical contacts in the first recess; and
a second group of electrical contacts in the second recess, wherein
each of the first recess and the second recess is configured to receive a battery pack.

2: The charger assembly of claim 1, further comprising a charging status indicator.

3: The charger assembly of claim 1, further comprising:
a first printed circuit board (PCB) electrically connected to the first group of electrical contacts; and
a second PCB electrically connected to the second group of electrical contacts.

4: The charger assembly of claim 3, wherein the first PCB and the second PCB have identical shapes.

5: The charger assembly of claim 1, wherein the housing further includes:
a third recess in the first surface; and
a fourth recess in the second surface.

6: The charger assembly of claim 5, wherein the housing further includes a second opening that connects the third recess and the fourth recess.

7: The charger assembly of claim 1, further comprising a detachable wall mount bracket.

8: The charger assembly of claim 7, wherein a first angle between the first surface of the housing and the detachable wall mount bracket is equal to a second angle between the second surface of the housing and the detachable wall mount bracket.

9: The charger assembly of claim 7, further comprising:
shoulder screws or nobs provided on the detachable wall mount bracket; and
keyholes provided in the housing, wherein
the keyholes receive the shoulder screws or nobs when the charger assembly is attached to the detachable wall mount bracket.

10: The charger assembly of claim 7, further comprising:
a tab provided on the wall mount bracket; and
a latch provided on or in the housing, wherein
the latch engages the tab when the charger assembly is attached to the detachable wall mount bracket.

11: The charger assembly of claim 1, further comprising:
a detachable base plate, wherein
the detachable base plate is perpendicular to the first surface and the second surface.

12: The charger assembly of claim 1, wherein an angle between the first surface and the second surface is changeable.

13: A charger system comprising:
the charger assembly of claim 1;
a first battery pack in the first recess; and
a second battery pack in the second recess.

14: The charger system of claim 13, wherein both the first battery pack and the second battery pack are removable from the charger assembly using the first opening.
